(19) United States
(12) Patent Application Publication
(10) Pub. No.: US 2016/0239354 A1
(43) Pub. Date: Aug. 18, 2016

(54) ENABLEMENT OF DISABLED NOTIFICATION

(71) Applicant: NOKIA TECHNOLOGIES OY, Espoo (FI)

(72) Inventors: Wei SHEN, Beijing (CN); Christian Rossing KRAFT, Bangkok (TH)

(73) Assignee: Nokia Technologies Oy, Espoo (FI)

(21) Appl. No.: 15/023,846

(22) PCT Filed: Sep. 25, 2013
(86) PCT No.: PCT/CN2013/084202

§ 371 Date: Mar. 22, 2016

(51) Int. Cl. G06F 9/54; G06F 3/0484; H04M 1/725

(52) U.S. Cl. CPC G06F 9/542; H04M 1/72566; G06F 3/0484

(57) ABSTRACT

A method comprising causing actuation of a notification indicative of occurrence of an event, receiving an indication of a notification disablement input associated with the notification, causing disablement of the notification based, at least in part, on the notification disablement input, receiving an indication of a notification enablement input associated with the notification, and causing enablement of the notification based, at least in part, on the notification enablement input is disclosed.

### TECHNICAL FIELD

The present application relates generally to enablement of a disabled notification.

### BACKGROUND

Electronic apparatuses, such as mobile communication apparatuses, are becoming more and more versatile. Apparatuses can perform numerous functions and a user can provide inputs that will cause an apparatus to take desired actions or change its behavior based on the inputs. It may be desirable for user input associated with an apparatus to be convenient for the user. It may also be desirable to design the apparatus so that the apparatus does what the user wants it to do in response to input from the user.

### SUMMARY

Various aspects of examples of the invention are set out in the claims.

One or more embodiments may provide an apparatus, a computer readable medium, a non-transitory computer readable medium, a computer program product, and a method to cause actuation of a notification indicative of occurrence of an event, receive an indication of a notification disablement input associated with the notification, cause disablement of the notification based, at least in part, on the notification disablement input, such that the disablement of the notification prevents a subsequent actuation of the notification of occurrence of the event, receive an indication of a notification enablement input associated with the notification, and cause enablement of the notification based, at least in part, on the notification enablement input, such that the enablement causes a subsequent actuation of the notification of occurrence of the event.

One or more embodiments may provide an apparatus, a computer readable medium, a computer program product, and a non-transitory computer readable medium having means for causing actuation of a notification indicative of occurrence of an event, means for receiving an indication of a notification disablement input associated with the notification, means for causing disablement of the notification based, at least in part, on the notification disablement input, such that the disablement of the notification prevents a subsequent actuation of the notification of occurrence of the event, means for receiving an indication of a notification enablement input associated with the notification, and means for causing enablement of the notification based, at least in part, on the notification enablement input, such that the enablement causes a subsequent actuation of the notification of occurrence of the event.

In at least one example embodiment, the actuation of the notification comprises causation of display of a visual indication of the notification.

In at least one example embodiment, the actuation of the notification comprises causation of rendering of an audible indication of the notification.

In at least one example embodiment, the actuation of the notification comprises causation of actuation of a tactile indication of the notification.

In at least one example embodiment, the event relates to at least one of a calendar event or an alarm event.

In at least one example embodiment, the notification disablement input is distinct from a notification deferment input.

In at least one example embodiment, the notification disablement input is distinct from an event disablement input.

One or more example embodiments further perform causation of display of a notification disablement interface element, wherein the notification disablement input relates to an input that corresponds with the notification disablement interface element.

In at least one example embodiment, the causation of display of the notification disablement interface element is based, at least in part, on a determination that the event occurred.

In at least one example embodiment, the notification disablement interface element is distinct from a notification deferment interface element.

In at least one example embodiment, the notification disablement interface element is distinct from an event disablement interface element.

In at least one example embodiment, receipt of the indication of the notification disablement input comprises receipt of an indication of an input, and determination that the input is the notification disablement input.

In at least one example embodiment, the notification disablement input relates to a gesture input.

In at least one example embodiment, the gesture input relates to at least one of a motion gesture input or a touch gesture input.

In at least one example embodiment, the motion gesture input relates to a shaking input.

One or more example embodiments further perform causation of display of a notification deferment interface element, wherein the notification disablement input fails to correspond with the notification deferment interface element.

In at least one example embodiment, the causation of display of the notification deferment interface element is based, at least in part, on a determination that the event occurred.

In at least one example embodiment, the notification deferment interface element is distinct from a notification disablement interface element.

In at least one example embodiment, the notification deferment interface element is distinct from an event disablement interface element.

One or more example embodiments further perform causation of another actuation of the notification indicative of occurrence of the event, receipt of an indication of a notification deferment input associated with the notification, and causation of deferment of the notification based, at least in part, on the notification deferment input, wherein the notification indicative of the event is based, at least in part, on a determination that a deferment period has elapsed.

In at least one example embodiment, the notification deferment input corresponds with a notification deferment interface element.

In at least one example embodiment, receipt of the indication of the notification deferment input comprises receipt of an indication of an input, and determination that the input is the notification deferment input.

In at least one example embodiment, the notification deferment input relates to a gesture input.

In at least one example embodiment, the gesture input relates to at least one of a motion gesture input or a touch gesture input.

In at least one example embodiment, the motion gesture input relates to a tap input.

In at least one example embodiment, the disablement of the notification precludes deferment of the notification of occurrence of the event.

In at least one example embodiment, the disablement of the notification is distinct from a deferment of the notification of occurrence of the event.

In at least one example embodiment, the disablement of the notification is distinct from a disablement of the event.

One or more example embodiments further perform causation of display of a notification enablement interface element, wherein the notification enablement input corresponds with the notification enablement interface item.

In at least one example embodiment, receipt of the indication of the notification enablement input comprises receipt of an indication of an input, and determination that the input is the notification enablement input.

In at least one example embodiment, the notification enablement input relates to a gesture input.

In at least one example embodiment, the gesture input relates to at least one of a motion gesture input or a touch gesture input.

In at least one example embodiment, the motion gesture input relates to a shaking input.

In at least one example embodiment, the receipt of the notification enablement input is subsequent to disablement of the notification of occurrence of the event.

In at least one example embodiment, the receipt of the notification enablement input is prior to a subsequent occurrence of the event.

In at least one example embodiment, the notification enablement input is distinct from a notification deferment input.

In at least one example embodiment, the notification enablement input is distinct from an event enablement input.

In at least one example embodiment, the receipt of the notification enablement input is performed absent performance of a screen transition subsequent to the disablement of the notification.

In at least one example embodiment, the receipt of the notification enablement input is performed absent causation of display of a menu subsequent to the disablement of the notification, the menu being associated with management of the event.

One or more example embodiments further perform determination that the event has occurred, wherein the causation of actuation of the notification is caused by the determination that the event has occurred.

One or more example embodiments further perform receipt of information indicative of an event enablement input, and causation of enablement of determination of occurrence of the event.

In at least one example embodiment, determination that the event has occurred comprises determination that circumstances that correspond with a criteria for the event have occurred.

One or more example embodiments further perform disablement of the event such that, subsequent to the disablement of the event, the apparatus is configured to avoid causation of actuation of a notification based, at least in part, on a subsequent occurrence of the event.

In at least one example embodiment, enablement of the notification comprises setting the notification to occur after a deferment period.

In at least one example embodiment, the deferment period relates to deferment from a time of the notification enablement input.

In at least one example embodiment, the deferment period relates to deferment from a time of the notification disablement input.

In at least one example embodiment, the deferment period relates to deferment from a time of the actuation of the notification.

One or more example embodiments further perform determination that a deferment period has elapsed based, at least in part, on the enablement of the notification, and causation of another actuation of the notification indicative of occurrence of the event, based, at least in part, on the determination that the deferment period has elapsed and the enablement of the notification.

One or more example embodiments further perform preclusion of enablement of the notification.

One or more example embodiments further perform determination that a predetermined time has elapsed since disablement of the notification, wherein the preclusion of enablement of the notification is based, at least in part, on the determination that the predetermined time has elapsed.

In at least one example embodiment, preclusion of enablement of the notification comprises receipt of the notification enablement input and absence of enablement of the notification.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to an example embodiment;

FIGS. 2A-2B are diagrams illustrating notifications according to at least one example embodiment;

FIGS. 3A-3B are diagrams illustrating enablement and/or disablement of an event according to at least one example embodiment;

FIG. 4 is a diagram illustrating a notification enablement interface element according to at least one example embodiment;

FIG. 5 is a flow diagram illustrating activities associated with enablement of a disabled notification according to at least one example embodiment;

FIG. 6 is a flow diagram illustrating activities associated with enablement of a disabled notification according to at least one example embodiment;

FIG. 7 is a flow diagram illustrating activities associated with enablement of a disabled notification according to at least one example embodiment;

FIG. 8 is a flow diagram illustrating activities associated with enablement of a disabled notification according to at least one example embodiment;

FIG. 9 is a flow diagram illustrating activities associated with enablement of a disabled notification according to at least one example embodiment;

FIG. 10 is a flow diagram illustrating activities associated with enablement of a disabled notification according to at least one example embodiment; and

FIG. 11 is a flow diagram illustrating activities associated with enablement of a disabled notification according to at least one example embodiment.

### DETAILED DESCRIPTION OF THE DRAWINGS

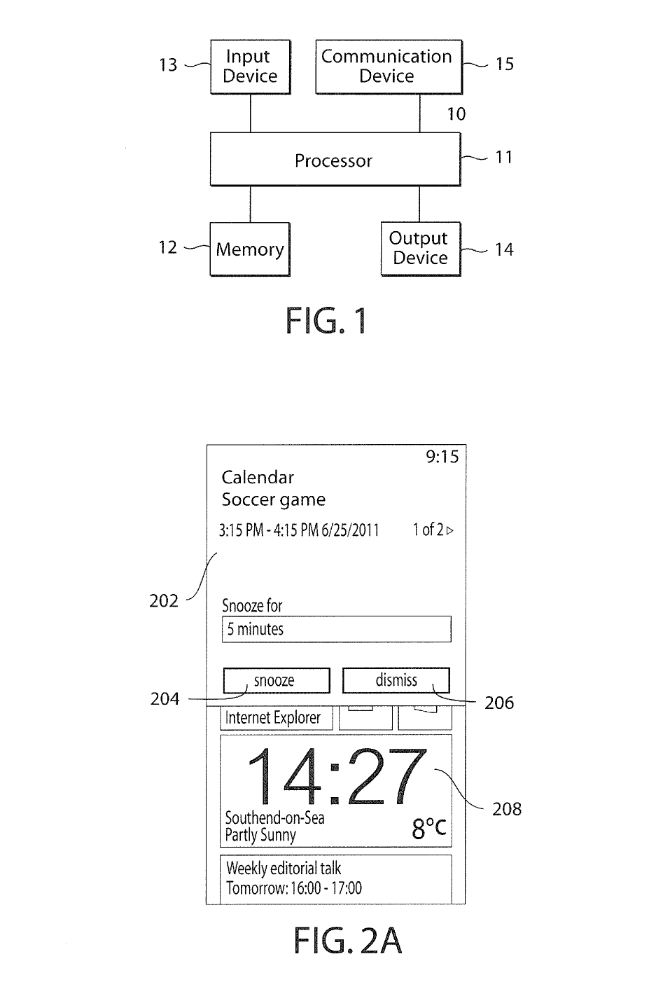

An embodiment of the invention and its potential advantages are understood by referring to FIGS. 1 through 11 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a portable digital assistant (PDAs), a pager, a mobile computer, a desktop computer, a television, a gaming apparatus, a laptop computer, a media player, a camera, a video recorder, a mobile phone, a global positioning system (GPS) apparatus, and/or any other types of electronic systems. Moreover, the apparatus of at least one example embodiment need not be the entire electronic apparatus, but may be a component or group of components of the electronic apparatus in other example embodiments.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may relate to information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

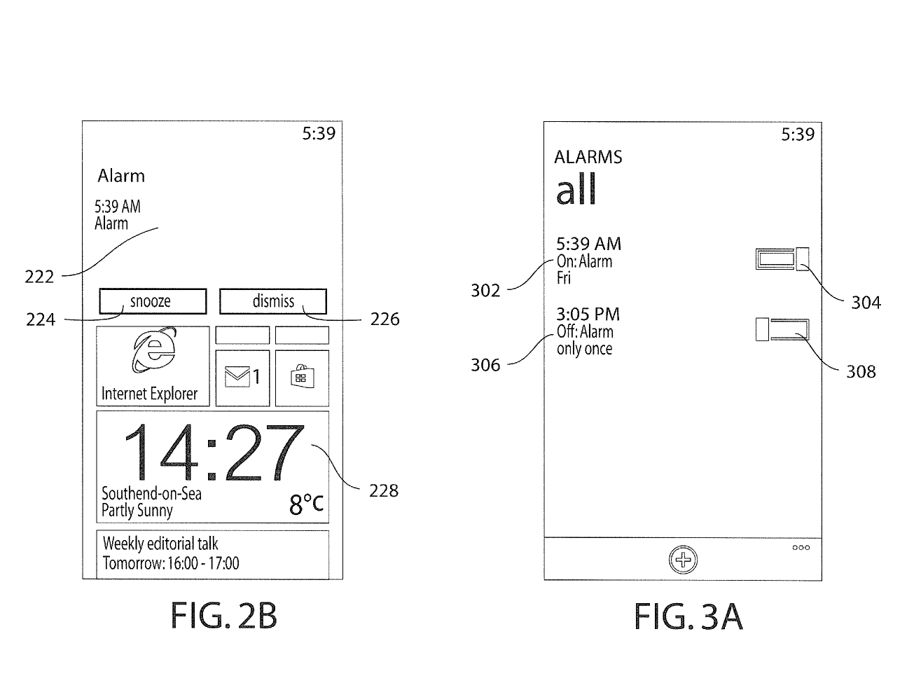

FIGS. 2A-2B are diagrams illustrating notifications according to at least one example embodiment. The examples of FIGS. 2A-2B are merely examples and do not limit the scope of the claims. For example, visual representation may vary, interface elements may vary, content of the notification may vary, and/or the like.

In many circumstances, users may desire to be notified of events that occur in relation to an apparatus. An event may relate to any designated circumstance that may occur regarding an apparatus. In at least one example embodiment, such designated circumstances relate to one or more criteria for the event. For example, the event may be a time related event, a condition related event, an environment related event, and/or the like. A time related event may relate to an event associated with chronology. For example, a time related event may relate to a determination that a current time correlates with a predetermined chronological criteria. In such an example, a predetermined chronological criteria may relate to a current day, date, time, and/or the like, such that determination of correspondence between the current time and the predetermined chronological criteria indicates occurrence of the time related event. For example, a predetermined chronological criteria may be associated with a calendar event, an alarm event and/or the like. A calendar event may relate an event that identifies correspondence between a current time and a designated time associated with the calendar event, such as a reminder, a start time, an end time, a departure time, and/or the like. In another example, a predetermined chronological criteria may relate to an alarm event. An alarm event may relate to a current time corresponding to a predetermined time associated with the alarm. For example, an alarm may relate to a wakeup alarm, a timer alarm, and/or the like. Such an alarm may be indicative of functionality related to an alarm clock, functionality of a countdown timer, and/or the like.

In at least one example embodiment, an apparatus may determine occurrence of an event. In at least one example embodiment, determination that the event has occurred comprises determination that one or more circumstances correspond with at least one criterion for the event have occurred. For example, such circumstances may relate to a current time, a current environmental factor, a receipt of input, receipt of a signal, entry of a designated state, and/or the like. Accordingly, in at least one example embodiment, an apparatus determines an event has occurred by monitoring circumstances comprising one or more parameters to determine if a value of one or more of monitored parameter(s) meet the one or more values of one or more corresponding parameter(s) comprising the criteria for that particular event. In at least one example embodiment, such parameters are based on time, but in some embodiments it may be possible to use a parameter may be based on date, day of the week, geographical location and/or boundary and/or distance from a fixed point or height or other appropriate monitored In some circumstances, a user may desire to be notified that an event has occurred. In at least one example embodiment, an apparatus causes actuation of a notification indicative of occurrence of an event. For example, causation of actuation of the notification may be caused by a determination that the event has occurred.

The notification may be any output that the apparatus provides to the user that signifies occurrence of the event. The notification may relate to any suitable user perceptible indication. For example, the notification may indicate the event by way of visual indication, tactile indication, audible indication, a deformation of the apparatus and/or a change in the thermal output of the apparatus, and/or the like.

In some circumstances, the notification may unambiguously indicate the event. For example, the notification may relate to visual information that identifies at least a type of the event, a title of the event, criteria of the event, and/or the like. In another example, the notification may relate to an audible indication that may differ from an audible indication attributable to a different activity of the apparatus, a different event, and/or the like. In another example, the notification may relate to a tactile indication that may differ from a tactile indication attributable to a different activity of the apparatus, a different event, and/or the like. In at least one example embodiment, actuation of the notification relates to an output device performing an action that provides for perception of the notification. For example actuation of the notification may relate to display of information indicative of the notification, rendering audio information indicative of the notification, inducement of a tactile sensation indicative of the notification, and/or the like. The apparatus may cause actuation of the notification by way of sending information to a separate apparatus to induce the actuation of the notification by way of the separate apparatus or a different separate apparatus, by way of performing the actuation, and/or the like.

In at least one example embodiment, the notification is indicative of a particular event. For example, the notification may indicate a particular occurrence of the event. In such an example, the notification fails to correspond with a different occurrence of the event. For example, upon occurrence of an event, the apparatus may cause actuation of a notification. However, upon a different occurrence of the same event, the apparatus may cause actuation of a different notification based, at least in part, on the different occurrence of the same event.

In many circumstances, a user may desire to cause termination of actuation of a notification that an event occurred. In some circumstances, the user may desire to disable the notification, such that the apparatus no longer provides notifications that the event occurred. For example, a user may desire to no longer be notified that a current time has corresponded with a particular alarm time. In such circumstances, the user may desire to perform an input that allows the apparatus to determine that the user desires such disablement of the notification. In some circumstances, the user may desire to defer the notification that the event has occurred. For example, the user may desire to address the circumstances of the event at a later time. In such an example, the user may desire to utilize snooze functionality associated with an alarm event, may desire to defer addressing a calendar event, and/or the like. In such an example, the user may desire to terminate the actuation of the notification, and to cause a later actuation of the notification at a later time. In such circumstances, the user may desire to perform an input that allows the apparatus to determine that the user desires such deferment of the notification. In at least one example embodiment, the apparatus receives an indication of a notification disablement input. For example, a user of the apparatus may provide a notification disablement input to the apparatus when the user wishes for the indication of the notified event to cease. In at least one example embodiment, the notification disablement input relates to an input that is related to causation of disablement of the notification that the event has occurred. For example, the notification disablement input may relate to an input that allows the apparatus to identify the input as a communication from the user of a desire to disable the notification of the event. In at least one example embodiment, the notification disablement input relates to a gesture input. A gesture input may relate to a motion gesture input, a touch gesture input, and/or the like. For example, the motion gesture input may relate to an input that corresponds with movement in accordance with a predetermined motion pattern. The movement may relate to movement of an object perceived by the apparatus, movement of the apparatus, and/or the like. For example, the gesture input may relate to shaking of the apparatus, turning the apparatus to face a different direction, and/or the like. In another example, the touch gesture may relate to a touch input that corresponds with a predetermined touch pattern. For example, the touch pattern may relate to a shape, a number of contact regions, a sequence of touch inputs, and/or the like. In at least one example of an embodiment, the gesture input may comprise one or more hover gestures or a sequence of hover gestures which are sensed using appropriate sensors and/or using an appropriate camera functionality provided on the apparatus. In at least one example embodiment, the apparatus causes display of a notification disablement interface element. In at least one example embodiment, an interface element relates to any element configured for detecting input and/or an element that indicates an input that may be performed such that the apparatus may interpret the input to be a particular input. For example, the interface element may be a button, a visual representation of a button, a visual representation of a selectable item, and/or the like.

In at least one example embodiment, the notification disablement input relates to an input that corresponds with the notification disablement interface element. In at least one example embodiment, the causation of display of the notification disablement interface element is based, at least in part, on a determination that the event occurred. For example, the causation of display of the notification disablement interface element may be caused by a determination that the event occurred. For example, if the notification relates to an alarm clock alert, the apparatus may provide a notification disablement interface element labeled “dismiss alarm.” In such an example, the apparatus may determine that an input associated with selection of the interface item, such as a touch input at a position that corresponds with the interface item, is a notification disablement input.

In at least one example embodiment, the apparatus causes disablement of the notification based, at least in part, on the notification disablement input. For example, the apparatus may prevent a subsequent actuation of the notification of occurrence of the event. In this manner, disablement of the notification may be caused by the notification disablement input.

In at least one example embodiment, the apparatus receives an indication of a notification deferment input. In at least one example embodiment, the notification deferment input relates to an input that is related to causation of deferment of the notification that the event has occurred. For example, the notification deferment input may relate to an input that allows the apparatus to identify the input as a communication from the user of a desire to defer the notification of the event. In at least one example embodiment, the notification deferment input relates to a gesture input.

In at least one example embodiment, the apparatus causes display of a notification deferment interface element. In at least one example embodiment, the notification deferment input relates to an input that corresponds with the notification deferment interface element. In at least one example embodiment, the causation of display of the notification deferment interface element is based, at least in part, on a determination that the event occurred. For example, the causation of display of the notification deferment interface element may be caused by a determination that the event occurred.

In at least one example embodiment, the apparatus causes deferment of the notification based, at least in part, on the notification deferment input. For example, deferment of the notification may be caused by the notification deferment input. In at least one example embodiment, deferment of a notification relates to termination of the actuation of the notification such that the apparatus causes another actuation of the notification based, at least in part, on a determination that a deferment period has elapsed. For example the apparatus may cause another actuation of the notification based, at least in part, on a determination that a deferment period has elapsed since receipt of the notification deferment input, actuation of the notification, occurrence of the event, and/or the like. In at least one example embodiment, a deferment period relates to a time interval after which the apparatus performs another actuation of the notification based, at least in part on a deferment of the notification.

In at least one example embodiment, a notification disablement input is distinct from a notification deferment input. For example, there may be an input associated with notification deferment and a different input associated with notification disablement. In at least one example embodiment, a notification disablement interface element is distinct from a notification deferment interface element. For example, there may be an interface element associated with notification deferment and a different interface element associated with notification disablement. For example, the notification disablement input may fail to correspond with a notification deferment interface element. In another example, the notification deferment input may fail to correspond with a notification disablement interface element.

In at least one example embodiment, disablement of the notification is distinct from a deferment of the notification of occurrence of the event. For example, disablement of the notification may preclude deferment of the notification of occurrence of the event. For example, disablement of the notification may prevent the apparatus from performing another actuation of the notification based, at least in part, on elapse of a deferment period.

FIG. 2A is a diagram illustrating a notification according to at least one example embodiment. The example of FIG. 2A illustrates a visual notification 202 associated with a calendar event. The apparatus may cause actuation of visual notification 202 based, at least in part, on determination that the calendar event has occurred. The example of FIG. 2A illustrates notification deferment interface element 204 and notification disablement interface element 206. It can be seen that visual notification 202, notification deferment interface element 204, and notification disablement interface element 206 are caused to be displayed to overlay at least part of screen 208. In at least one example embodiment, a screen relates to a set of information that is displayed. For example, a screen may relate to a set of information associated with a particular program, a home screen, and idle screen, a lock screen, and/or the like.

FIG. 2B is a diagram illustrating a notification according to at least one example embodiment. The example of FIG. 2B illustrates a visual notification 222 associated with an alarm event. The apparatus may cause actuation of visual notification 222 based, at least in part, on determination that the calendar event has occurred. The example of FIG. 2B illustrates notification deferment interface element 224 and notification disablement interface element 226. It can be seen that visual notification 222, notification deferment interface element 224, and notification disablement interface element 226 are caused to be displayed to overlay screen 228.

Even though the examples of FIGS. 2A-2B indicate copresence of a notification deferment interface element and a notification disablement interface element, any combination of such interface elements and absence of such interface elements may be provided.

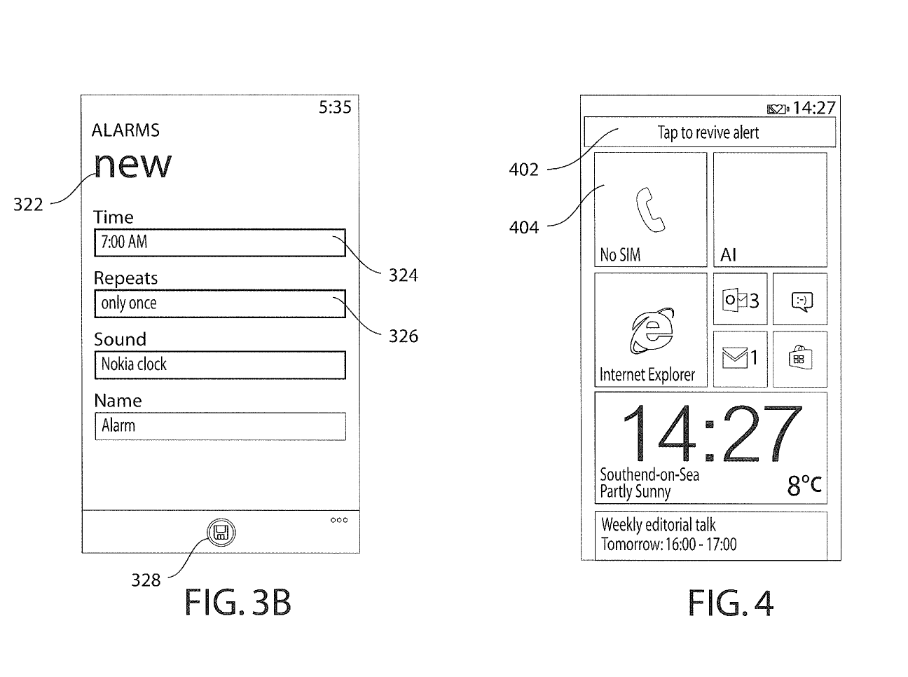

FIGS. 3A-3B are diagrams illustrating enablement and/or disablement of an event according to at least one example embodiment. The examples of FIGS. 3A-3B are merely examples and do not limit the scope of the claims. For example, visual representation may vary, information associated with the event may vary, manner of interaction may vary, and/or the like.

In some circumstances, a user may desire to enable and/or disable an event. For example, the user may desire to avoid having the apparatus determine occurrences of the event, avoid having the apparatus provide notifications of occurrences of the event, and/or the like. In at least one example embodiment, the apparatus causes enablement of an event. In at least one example embodiment, enablement of an event relates to causing the apparatus to be configured to determine occurrence of the event, cause actuation of a notification based, at least in part, on determination that the event occurred, and/or the like. In at least one example embodiment, the apparatus causes disablement of the event. In at least one example embodiment, disablement of an event relates to causing the apparatus to be configured to avoid determination of occurrence of the event, preclude actuation of a notification based, at least in part, on determination that the event occurred, and/or the like. For example, disablement of the event may be performed such that, subsequent to the disablement of the event, the apparatus is configured to avoid causation of actuation of a notification based, at least in part, on a subsequent occurrence of the event.

In at least one example embodiment, the apparatus receives an indication of an event enablement input. In at least one example embodiment, the event enablement input relates to an input that is related to causation of enablement of the event. For example, the event enablement input may relate to an input that allows the apparatus to identify the input as a communication from the user of a desire to enablement the event. In at least one example embodiment, the event enablement input relates to a gesture input.

In at least one example embodiment, the apparatus receives an indication of an event disablement input. In at least one example embodiment, the event disablement input relates to an input that is related to causation of disablement of the event. For example, the event disablement input may relate to an input that allows the apparatus to identify the input as a communication from the user of a desire to disable the event. In at least one example embodiment, the event disablement input relates to a gesture input.

In at least one example embodiment, the apparatus causes display of an event enablement interface element. In at least one example embodiment, the event enablement input relates to an input that corresponds with the event enablement interface element. In at least one example embodiment, the apparatus causes display of an event disablement interface element. In at least one example embodiment, the event disablement input relates to an input that corresponds with the event disablement interface element.

In at least one example embodiment, the apparatus causes enablement of the event based, at least in part, on the event enablement input. For example, enablement of the event may be caused by the event enablement input. In at least one example embodiment, the apparatus causes disablement of the event based, at least in part, on the event disablement input. For example, disablement of the event may be caused by the event disablement input.

In at least one example embodiment, an event enablement input is distinct from a notification deferment input. For example, there may be an input associated with notification deferment and a different input associated with event enablement. In at least one example embodiment, an event enablement interface element is distinct from a notification deferment interface element. For example, there may be an interface element associated with notification deferment and a different interface element associated with event enablement. For example, the event enablement input may fail to correspond with a notification deferment interface element. In another example, the notification deferment input may fail to correspond with an event enablement interface element.

In at least one example embodiment, an event disablement input is distinct from a notification deferment input. For example, there may be an input associated with notification deferment and a different input associated with event disablement. In at least one example embodiment, an event disablement interface element is distinct from a notification deferment interface element. For example, there may be an interface element associated with notification deferment and a different interface element associated with event disablement. For example, the event disablement input may fail to correspond with a notification deferment interface element. In another example, the notification deferment input may fail to correspond with an event disablement interface element.

In at least one example embodiment, an event enablement input is distinct from a notification disablement input. For example, there may be an input associated with notification disablement and a different input associated with event enablement. In at least one example embodiment, an event enablement interface element is distinct from a notification disablement interface element. For example, there may be an interface element associated with notification disablement and a different interface element associated with event enablement. For example, the event enablement input may fail to correspond with a notification disablement interface element. In another example, the notification disablement input may fail to correspond with an event enablement interface element.

In at least one example embodiment, an event disablement input is distinct from a notification disablement input. For example, there may be an input associated with notification disablement and a different input associated with event disablement. In at least one example embodiment, an event disablement interface element is distinct from a notification disablement interface element. For example, there may be an interface element associated with notification disablement and a different interface element associated with event disablement. For example, the event disablement input may fail to correspond with a notification disablement interface element. In another example, the notification disablement input may fail to correspond with an event disablement interface element.

FIG. 3A illustrates a screen associated with enablement and/or disablement of events. It can be seen that interface element 304 is both an event enablement interface element and an event disablement element that is associated with an alarm event indicated by event representation 302. It can be seen that interface element 308 is both an event enablement interface element and an event disablement element that is associated with an alarm event indicated by event representation 306. Interface elements 308 and 304 may be an event disablement interface element when an associated event is enabled. For example, receipt of an input associated with interface element 308 may cause a transition from event enablement to event disablement. Interface elements 308 and 304 may be an interface enablement interface element when an associated event is disabled. For example, receipt of an input associated with interface element 308 may cause a transition from event disablement to event enablement. In at least one example embodiment, the apparatus may transition from a different screen to the screen of FIG. 3A to allow a user to enable and/or disable an event. It can be seen that there is a setting that indicates enablement of determination of subsequent occurrences of the event associated with the events of representations 302 and 304. For example, the event indicated by representation 302 relates to an event that occurs each Friday. In another example, the event indicated by representation 304 relates to an event that occurs only once. In such an example, the apparatus may disable the event based, at least in part, on occurrence of the event.

FIG. 3B illustrates a screen associated with enablement and/or disablement of an event. It can be seen that interface element 324 identifies criteria for occurrence of the event. It can be seen that representation 322 identifies the event that may be enabled/disabled by way of the screen of example 3B. In at least one example embodiment, the apparatus may transition from a different screen to the screen of FIG. 3B to allow a user to enable and/or disable an event. It can be seen that there is a setting 326 that indicates enablement of determination of subsequent occurrences of the event associated with the event. For example, the event relates to an event that occurs only once. In such an example, the apparatus may disable the event based, at least in part, on occurrence of the event. In at least one example embodiment, icon 328 relates to an event enablement interface item. For example, the apparatus may enable determination of occurrence of the event based, at least in part, on an input corresponding with interface element 328. For example, the apparatus may store the settings of the example of FIG. 3B based, at least in part, on receipt of input corresponding to icon 328. In at least one example embodiment, such storage may cause enablement of the event.

FIG. 4 is a diagram illustrating a notification enablement interface element according to at least one example embodiment. The example of FIG. 4 is merely an example and does not limit the scope of the claims. For example, visual representation may vary, content may vary, location of the notification enablement interface element may vary, and/or the like.

In some circumstances, a user may inadvertently disable a notification. For example, the user may be inattentive, unaware, distracted, and/or the like. For example, a user may desire to defer the notification by performing a notification deferment input, but instead may accidentally perform a notification disablement input. In such an example, the user may be attempting to perform a snooze input for an alarm clock, but may be too tired to accurately perform the input. In another example, the user may receive a calendar event notification, but may be distracted by performance of another task. In such an example, the user may accidentally perform a notification disablement input instead of a notification deferment input. In such circumstances, the user may remain inattentive, unaware, distracted, and/or the like after performing the inadvertent input. In some circumstances, it may be desirable to allow the user to perform a corrective input that avoids the inadvertent disablement. However, it may further be desirable to allow such input in a simple and intuitive manner. For example, it may be desirable to allow the user to perform the input without transitioning to a different screen, without performing any complex inputs, and/or the like. For example, it may be desirable to limit the amount of increased attentiveness associated with performance of the corrective input, over the level of attentiveness associated with the inadvertent input. In such an example, it may be desirable to avoid necessity of the user becoming unduly wakened further to correct an inadvertent notification disablement. It may also be desirable to avoid distracting a user from a task that caused the user to inadvertently disable the notification.

In at least one example embodiment, the apparatus receives an indication of a notification enablement input associated with the notification. In at least one example embodiment, the notification enablement input relates to an input that is related to causation of enablement of the notification that the event has occurred. For example, the notification enablement input may relate to an input that allows the apparatus to identify the input as a communication from the user of a desire to allow subsequent actuation of the notification of the occurrence of the event. In at least one example embodiment, the notification enablement input relates to a gesture input. In at least one example embodiment, receipt of the notification enablement input is subsequent to disablement of the notification of occurrence of the event. For example, the apparatus may receive the notification enablement input subsequent to a notification disablement input that causes disablement of the notification. In at least one example embodiment, the receipt of the notification enablement input is prior to a subsequent occurrence of the event. The notification may be associated with the occurrence of the event and unassociated with a subsequent occurrence of the event.

In at least one example embodiment, the apparatus causes display of a notification enablement interface element. In at least one example embodiment, the notification enablement input relates to an input that corresponds with the notification enablement interface element. In at least one example embodiment, the causation of display of the notification enablement interface element is based, at least in part, on disablement of the notification. For example, the causation of display of the notification enablement interface element may be caused by performance of disablement of the notification.

In at least one example embodiment, the apparatus causes enablement of the notification based, at least in part, on the notification enablement input. For example, the apparatus may allow a subsequent actuation of the notification of occurrence of the event based, at least in part on the notification enablement input. In this manner, enablement of the notification may be caused by the notification enablement input.

In at least one example embodiment, a notification enablement input is distinct from a notification deferment input. For example, there may be an input associated with notification deferment and a different input associated with notification enablement. In at least one example embodiment, a notification enablement interface element is distinct from a notification deferment interface element. For example, there may be an interface element associated with notification deferment and a different interface element associated with notification enablement. For example, the notification enablement input may fail to correspond with a notification deferment interface element. In another example, the notification deferment input may fail to correspond with a notification enablement interface element.

In at least one example embodiment, an event enablement input is distinct from a notification enablement input. For example, there may be an input associated with notification enablement and a different input associated with event enablement. In at least one example embodiment, an event enablement interface element is distinct from a notification enablement interface element. For example, there may be an interface element associated with notification enablement and a different interface element associated with event enablement. For example, the event enablement input may fail to correspond with a notification enablement interface element. In another example, the notification enablement input may fail to correspond with an event enablement interface element.

The example of FIG. 4 illustrates notification enablement input element 402 in relation to screen 404. As previously described, it may be desirable to avoid undue increase in the attentiveness of the user attributable to performance of the notification enablement input. In at least one example embodiment, the receipt of the notification enablement input is performed absent performance of a screen transition subsequent to the disablement of the notification. For example, the apparatus may receive the notification enablement input while causing display of the same screen as displayed when the notification was disabled. However, in some circumstances, the apparatus may terminate display of one or more overlays on a screen. For example, the apparatus may receive the enablement input during display of screen 208 of the example of FIG. 2A, even though the apparatus may remove the overlay of visual notification 202, notification deferment interface element 204, and disablement interface element 206. In this manner, the apparatus may terminate display of the overlay of visual notification 202, notification deferment interface element 204, and disablement interface element 206, and cause display of notification enablement interface element 402 based, at least in part, on disablement of the notification. In at least one example embodiment, the receipt of the notification enablement input is performed absent causation of display of a menu subsequent to the disablement of the notification, the menu being associated with management of the event. For example, the apparatus may receive the notification enablement input absent navigation of any menu that may include a notification enablement menu item.

In at least one example embodiment, the apparatus may preclude enablement of the notification. For example, it may be desirable to restrict a user's ability to perform a notification enablement input to a predetermined time period. For example, it may be desirable to take measures to avoid overly prolonged ability to perform the notification enablement input. In at least one example embodiment, preclusion of enablement of the notification is based, at least in part, on the determination that a predetermined time has elapsed. In at least one example embodiment, preclusion of enablement of the notification comprises receipt of a notification enablement input and avoidance of enablement of the notification. In this manner, preclusion of enablement of the notification may comprise a failure to enable the notification upon receipt of the notification enablement input.

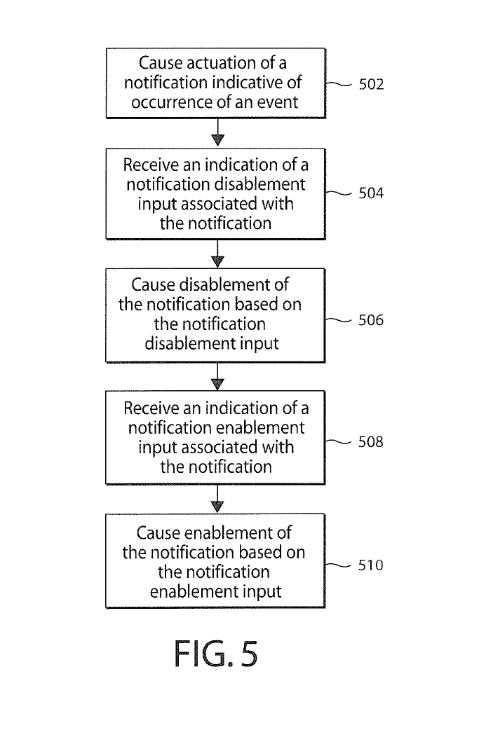

FIG. 5 is a flow diagram illustrating activities associated with enablement of a disabled notification according to at least one example embodiment. In at least one example embodiment, there is a set of operations that corresponds with the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 5.

At block 502, the apparatus causes actuation of a notification indicative of occurrence of an event. The causation, the actuation, the notification, the occurrence, and the event may be similar as described regarding FIGS. 2A-2B, and/or the like.

At block 504, the apparatus receives an indication of a notification disablement input associated with the notification. The receipt and the notification disablement input may be similar as described regarding FIGS. 2A-2B, and/or the like.

At block 506, the apparatus causes disablement of the notification based, at least in part, on the notification disablement input. The causation and the disablement may be similar as described regarding FIGS. 2A-2B, and/or the like.

At block 508, the apparatus receives an indication of a notification enablement input associated with the notification. The receipt and the notification enablement input may be similar as described regarding FIG. 4, and/or the like.

At block 510, the apparatus causes enablement of the notification based, at least in part, on the notification enablement input. The causation and the enablement may be similar as described regarding FIG. 4, and/or the like.

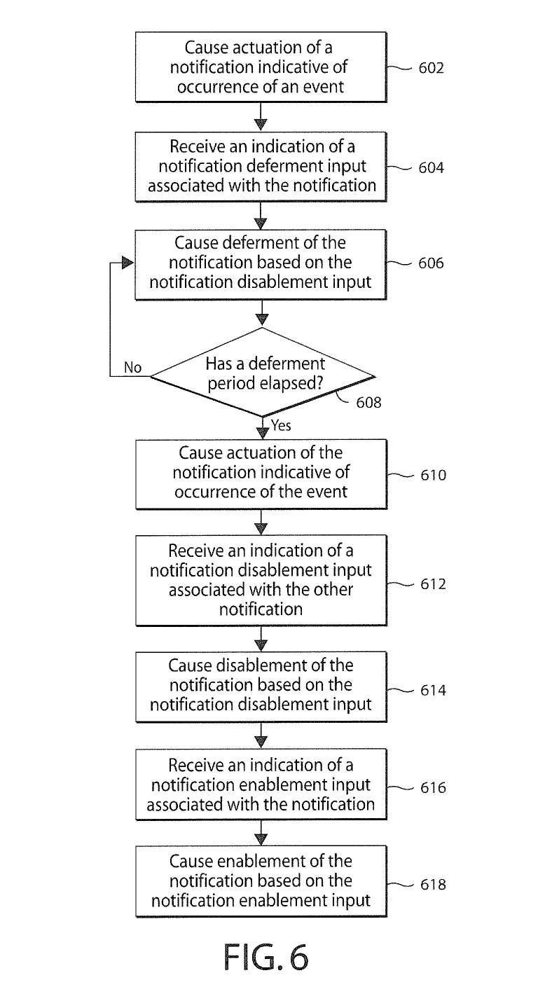

FIG. 6 is a flow diagram illustrating activities associated with enablement of a disabled notification according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

In some circumstance, it may be desirable to perform enablement of a disabled notification independent of whether the notification has been previously deferred. For example, the user may have previously performed a notification deferment input, but later inadvertently performs a notification disablement input when attempting to perform another notification deferment input. Similarly, it may be desirable to allow a user to defer a notification subsequent to enablement of the notification. For example, the user may inadvertently perform a notification disablement input, and then perform a notification enablement input. In such an example the user may desire to defer a subsequent notification.

At block 602, the apparatus causes actuation of a notification indicative of occurrence of an event, similarly as described regarding block 502 of FIG. 5.

At block 604, the apparatus receives an indication of a notification deferment input associated with the notification. The receipt and the notification deferment input may be similar as described regarding FIGS. 2A-2B, and/or the like.

At block 606, the apparatus causes of deferment of the notification based, at least in part, on the notification deferment input. The causation of deferment may be similar as described regarding FIGS. 2A-2B, and/or the like.

At block 608, the apparatus determines whether a deferment period has elapsed. The determination and the deferment period may be similar as described regarding FIGS. 2A-2B, and/or the like. If the apparatus determines that the deferment period has elapsed, flow proceeds to block 610. If the apparatus determines that the deferment period has failed to elapse, flow returns to block 606.

At block 610, the apparatus causes another actuation of the notification indicative of occurrence of the event. The causation and the other actuation may be similar as described regarding FIGS. 2A-2B, and/or the like. In this manner, the actuation of the notification indicative of the event is based, at least in part, on the determination that a deferment period has elapsed. For example, the actuation of the notification indicative of the event may be caused by the determination that a deferment period has elapsed.

At block 612, the apparatus receives an indication of a notification disablement input associated with the notification, similarly as described regarding block 504 of FIG. 5. At block 614, the apparatus causes disablement of the notification based, at least in part, on the notification disablement input, similarly as described regarding block 506 of FIG. 5. At block 616, the apparatus receives an indication of a notification enablement input associated with the notification, similarly as described regarding block 508 of FIG. 5. At block 618, the apparatus causes enablement of the notification based, at least in part, on the notification enablement input, similarly as described regarding block 510 of FIG. 5.

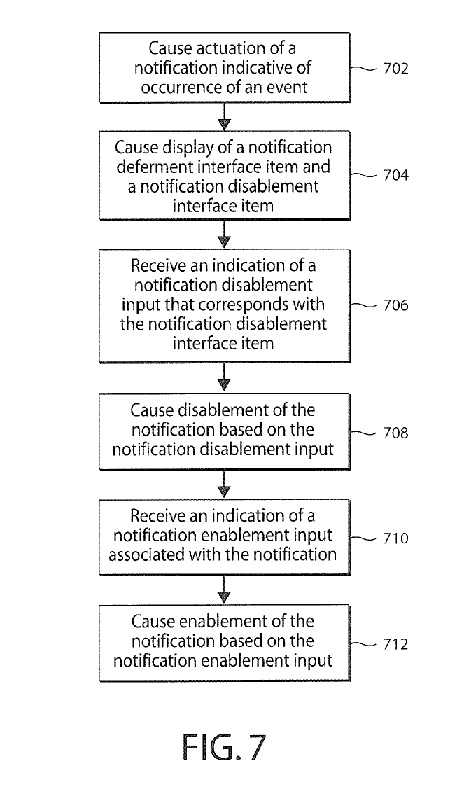

FIG. 7 is a flow diagram illustrating activities associated with enablement of a disabled notification according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

At block 702, the apparatus causes actuation of a notification indicative of occurrence of an event, similarly as described regarding block 502 of FIG. 5.

At block 704, the apparatus causes display of a notification disablement interface element and a notification deferment interface element. The causation, the notification disablement interface element, and the notification deferment interface element may be similar as described regarding FIGS. 2A-2B, and/or the like.

At block 706, the apparatus receives an indication of a notification disablement input that corresponds with the notification disablement interface item. The receipt and the notification disablement input may be similar as described regarding FIGS. 2A-2B, and/or the like.

At block 708, the apparatus causes disablement of the notification based, at least in part, on the notification disablement input, similarly as described regarding block 506 of FIG. 5. At block 710, the apparatus receives an indication of a notification enablement input associated with the notification, similarly as described regarding block 508 of FIG. 5. At block 712, the apparatus causes enablement of the notification based, at least in part, on the notification enablement input, similarly as described regarding block 510 of FIG. 5.

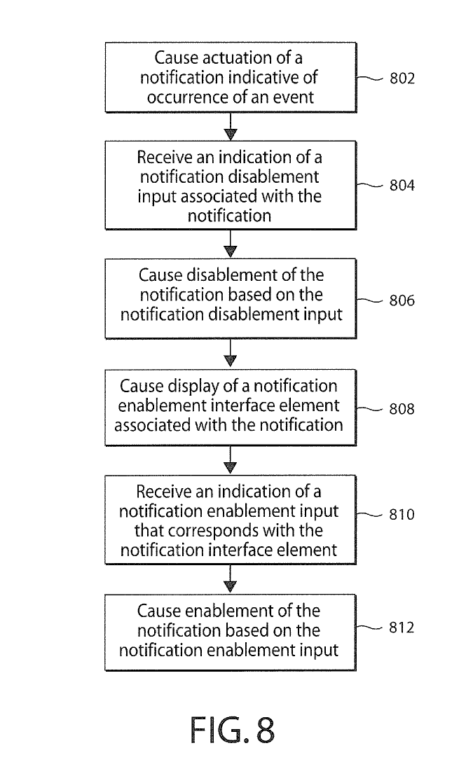

FIG. 8 is a flow diagram illustrating activities associated with enablement of a disabled notification according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

At block 802, the apparatus causes actuation of a notification indicative of occurrence of an event, similarly as described regarding block 502 of FIG. 5. At block 804, the apparatus receives an indication of a notification disablement input associated with the notification, similarly as described regarding block 504 of FIG. 5. At block 806, the apparatus causes disablement of the notification based, at least in part, on the notification disablement input, similarly as described regarding block 506 of FIG. 5.

At block 808, the apparatus causes display of a notification enablement interface element. The causation and the notification enablement interface element may be similar as described regarding FIG. 4, and/or the like.

At block 810, the apparatus receives an indication of a notification enablement input that corresponds with the notification interface element. The receipt and the notification enablement input may be similar as described regarding FIG. 4, and/or the like.

At block 812, the apparatus causes enablement of the notification based, at least in part, on the notification enablement input, similarly as described regarding block 510 of FIG. 5.

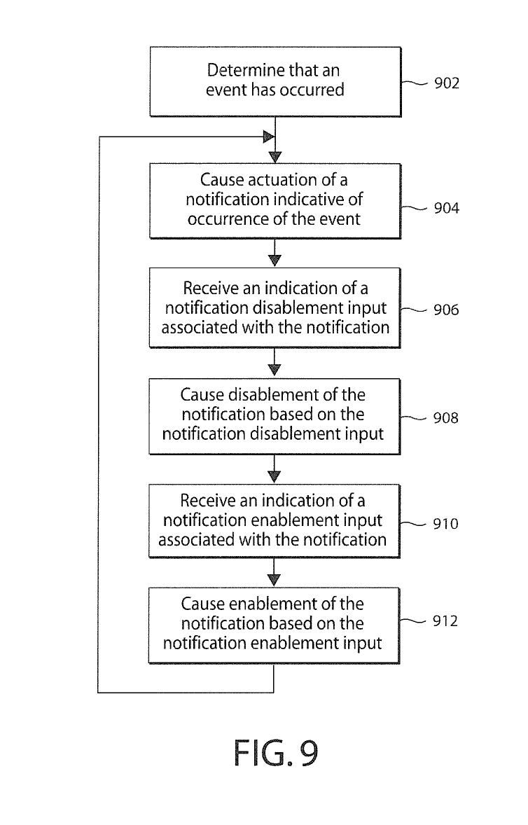

FIG. 9 is a flow diagram illustrating activities associated with enablement of a disabled notification according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

At block 902, the apparatus determines that an event has occurred. The determination and the event may be similar as described regarding FIGS. 2A-2B, and/or the like.

At block 904, the apparatus causes actuation of a notification indicative of occurrence of the event, similarly as described regarding block 502 of FIG. 5. In this manner, the causation of the actuation of the notification may be caused by the determination that the event has occurred.

At block 906, the apparatus receives an indication of a notification disablement input associated with the notification, similarly as described regarding block 504 of FIG. 5. At block 908, the apparatus causes disablement of the notification based, at least in part, on the notification disablement input, similarly as described regarding block 506 of FIG. 5. At block 910, the apparatus receives an indication of a notification enablement input associated with the notification, similarly as described regarding block 508 of FIG. 5. At block 912, the apparatus causes enablement of the notification based, at least in part, on the notification enablement input, similarly as described regarding block 510 of FIG. 5. Flow may return to block 904 so that the apparatus may cause another actuation of the notification.

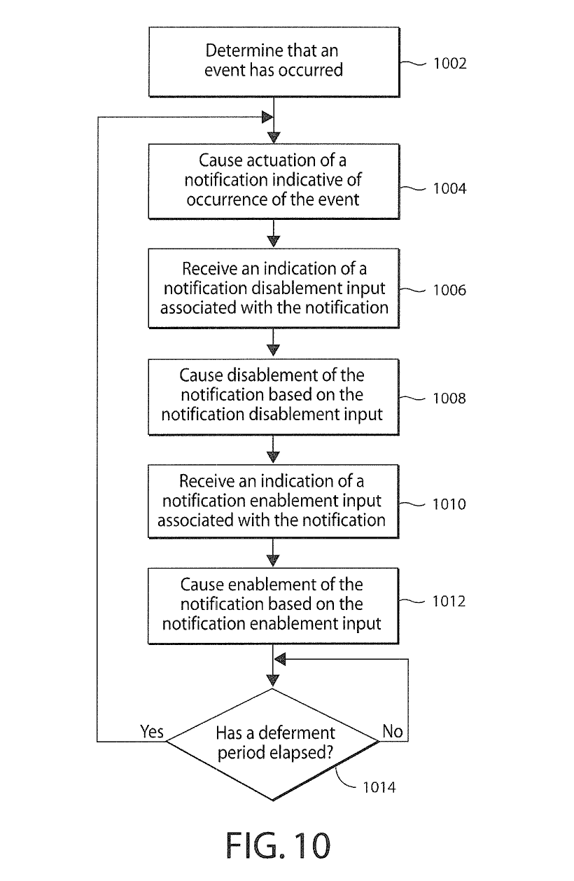

FIG. 10 is a flow diagram illustrating activities associated with enablement of a disabled notification according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

In some circumstances, the user may desire to defer an assertion of a notification after the user enables the notification. For example, the user may desire to avoid the assertion of the notification immediately after the user performs the notification enablement input. In this manner, it may be desirable for the next subsequent actuation of the notification, after the enablement of the notification, to occur at a time similar to a time of which a deferred notification would have been actuated, if the user would have provided a notification deferment input instead of a notification disablement input.

In at least one example embodiment, enablement of the notification comprises setting the notification to occur after a deferment period. The deferment period may relate to deferment from a time of the notification enablement input, deferment from a time of the notification disablement input, deferment from a time of the actuation of the notification, and/or the like.

At block 1002, the apparatus determines that an event has occurred, similarly as described regarding block 902 of FIG. 9. At block 1004, the apparatus causes actuation of a notification indicative of occurrence of the event, similarly as described regarding block 502 of FIG. 5. At block 1006, the apparatus receives an indication of a notification disablement input associated with the notification, similarly as described regarding block 504 of FIG. 5. At block 1008, the apparatus causes disablement of the notification based, at least in part, on the notification disablement input, similarly as described regarding block 506 of FIG. 5. At block 1010, the apparatus receives an indication of a notification enablement input associated with the notification, similarly as described regarding block 508 of FIG. 5. At block 1012, the apparatus causes enablement of the notification based, at least in part, on the notification enablement input, similarly as described regarding block 510 of FIG. 5.

At block 1014, the apparatus determines whether a deferment period has elapsed. If the apparatus determines that the deferment period has elapsed, flow returns to block 904 so that the apparatus may cause another actuation of the notification. If the apparatus determines that the deferment period has failed to elapse, flow remains at block 1014. The determination that the deferment period has elapsed may be based, at least in part, on the enablement of the notification. For example, the determination that the deferment period has elapsed may be caused by the enablement of the notification.

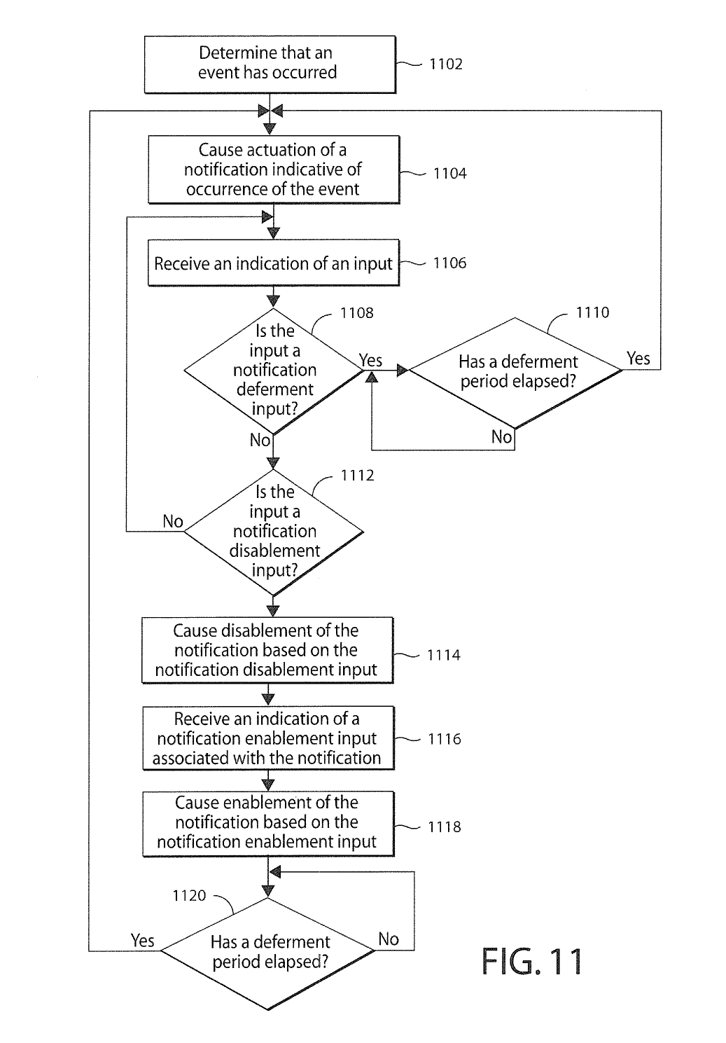

FIG. 11 is a flow diagram illustrating activities associated with enablement of a disabled notification according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

At block 1102, the apparatus determines that an event has occurred, similarly as described regarding block 902 of FIG. 9. At block 1104, the apparatus causes actuation of a notification indicative of occurrence of the event, similarly as described regarding block 502 of FIG. 5.

At block 1106, the apparatus receives an indication of an input. The receipt and the input may be similar as described regarding FIGS. 2A-2B, and/or the like.

At block 1108, the apparatus determines whether the input is a notification deferment input. The determination may be similar as described regarding FIGS. 2A-2B, and/or the like. If the apparatus determines that the input is a notification deferment input, flow proceeds to block 1110. If the apparatus determines that the input is not a notification deferment input, flow proceeds to block 1112.

At block 1110, the apparatus determines whether a deferment period has elapsed, similarly as described regarding block 608 of FIG. 6. If the apparatus determines that the deferment period has elapsed, flow returns to block 1104. In this manner, the apparatus may perform another actuation of the notification. If the apparatus determines that the deferment period has failed to elapse, flow remains at block 1110.

At block 1112, the apparatus determines whether the input is a notification disablement input. The determination and the notification disablement input may be similar as described regarding FIGS. 2A-2B, and/or the like. If the apparatus determines that the input is not a notification disablement input, flow returns to block 1106. If the apparatus determines that the input is the notification disablement input, flow proceeds to block 1114.

At block 1114, the apparatus causes disablement of the notification based, at least in part, on the notification disablement input, similarly as described regarding block 506 of FIG. 5. At block 1116, the apparatus receives an indication of a notification enablement input associated with the notification, similarly as described regarding block 508 of FIG. 5. At block 1118, the apparatus causes enablement of the notification based, at least in part, on the notification enablement input, similarly as described regarding block 510 of FIG. 5.

At block 1120, the apparatus determines whether a deferment period has elapsed, similarly as described regarding block 1014 of FIG. 10. If the apparatus determines that the deferment period has elapsed, flow returns to block 1104 so that the apparatus may cause another actuation of the notification. If the apparatus determines that the deferment period has failed to elapse, flow remains at block 1120.

To provide context to the above description, an example of an implementation that may benefit from the description above will be discussed. It should be understood that this example is merely to illustrate a manner in which some embodiments may be applied, and does not limit the scope of the claims in any way. This example relates to a possible implementation for an alarm clock program.

The example alarm clock program is installed and runs on an apparatus and can be configured by a user of the apparatus to generate alerts for one or more user-specified times. The user creates an alarm usually by way of interface elements such as, for example, those shown in FIG. 3B. Alternatively, a user may download or import alarm settings from another device.

For example, consider a scenario where a user sets the time in which the alarm application is to invoke an alert to the time criterion “7:00 AM”. When the user saves the alarm time, the alarm application running on the apparatus creates and/or enables an event that has the criterion of a time determined by the apparatus being 7:00 AM as triggering the alarm notification, such that when the current time becomes 7:00 AM, an alarm notification for an alarm event corresponding to the time as determined by the apparatus being 7:00 am is triggered. In this manner, an alarm relates to a time determined by the apparatus event. The apparatus may determine the time in any suitable way, for example it may receive timing information from a communications network. In some circumstances, enablement of the event of the alarm may cause the apparatus to request a message from a real time clock module to be received when the real time clock module determines that the current time is 7:00 AM. In this manner, the setting of the event may cause the alarm clock program to prepare data structures for receipt of the message that would inform the alarm clock program of the occurrence of the criterion then when the criterion is met (the time becoming 7:00 AM) of the event of the alarm.

In one example embodiment, when the time becomes 7:00 AM, the alarm clock program receives a message that informs the alarm clock program that the one or more criteria for the event of the alarm have occurred. Upon receipt of the message, the alarm clock program generates a notification to alert the user that the alarm conditions have occurred. The notification may relate to an audio signal and/or to a visual representation that may be similar to the example of FIG. 2B. The apparatus causes suitable actuation of the notification, for example, by way of playing an audio alarm notification signal and/or causing display of a visual alarm notification representation.

In some examples of embodiments as the alarm event is being notified, the execution of the notification for the alarm is disabled when the apparatus detects user input in the form of a permanent disablement, such as that a user may provide to “dismiss” the alarm, which ceases the generation of the notification alert. Dismissing an alarm event is in at least one example of an embodiment is distinguishable from the action of deferring the generation of the notification for an alarm event (such as may be provided by a snooze option) as the action of dismissing an alarm results in the user needing to configure the alarm program to edit a saved alarm event and/or generate a new alarm event if they wish to be notified for an event with new or with the same one or more notification criteria as that of the dismissed alarm. In an example embodiment where the alarm program allows the user to either dismiss the notification or to defer the notification (the so-called “snooze” option), if the user elects to defer the notification, the alarm program may terminate actuation of the notification (terminate display of the visual representation and the playing of the audio signal), and request to receive a message from a timer module when a deferment period has elapsed (for example a 10 minute snooze period). In this manner, the deferment may cause the apparatus to prepare data structures to receive the timer module message, and perform a subsequent actuation of the notification.

Consider an example of a scenario where the user may have intended to defer the notification, but accidentally dismissed the notification instead. In such circumstances, the user has several options using the example alarm program. Firstly, the user is able to generate a new alarm event or edit a saved alarm event or otherwise modify the one or more criteria of the dismissed alarm event so that the notification can be regenerated at a later time. For example, the user may navigate the interface using the navigation operations associated with transitioning to the screen of FIG. 3B, and then provide input to modify one or more saved alarm event criteria or generate a new alarm event with one or more new alarm event criteria, for example an alarm event associated with 7:10 AM. If the user pursues the latter option, the apparatus generates a new event with an event criteria of 7:10 AM. In this manner, the event may request the real time clock module of the apparatus to send a message to indicate that the current time is 7:10 AM. In this manner, the event may cause generation of a different notification when the alarm clock receives the message indicating occurrence of the current time being 7:10 AM. However, there exists a scenario where the user desires to avoid the above input process. For example, such a scenario exists when a user desires to perform less interaction with the apparatus to be able to receive a notification that would have been received if the user had deferred the notification instead of dismissed the notification.

In the example alarm program, the apparatus enables a user to perform a notification enablement input after a notification has been dismissed by retaining at least a portion of, the data structures associated with the notification even though the user previously dismissed the notification. The apparatus may utilize a data structure that corresponds with a deferred notification, even though the notification was dismissed and not deferred. The data structure may be saved and not actuated unless input is provided to reinstate the notification. Then, if the apparatus detects input to restore the notification, the notification is -re-enabled.

In some embodiments of the example alarm program, when an apparatus detects a notification enablement input (for example an input that serves to re-enable the notification), the notification is processed as if the notification had been previously deferred instead of dismissed. For example, if the dismissal caused the apparatus to utilize a data structure that corresponds with a deferred notification, but that will avoid actuation of the notification unless the notification has been enabled, the apparatus may modify the data structure to allow actuation of the notification.

In some embodiments of the example alarm program, when the apparatus detects a notification re-enablement input determines a duration that represents the remainder of the deferment period, if the notification would have been deferred instead of dismissed. In such embodiments, the apparatus may cause another actuation of the notification after such deferment period.

In either of these embodiments of the example alarm program, the user will be able to receive the desired alarm notification as if the user had deferred the notification instead of dismissed the notification, and may avoid the lengthy interaction associated with modifying the alarm event or creating a new alarm event.

In some circumstances, the apparatus may vary the manner in which the subsequent actuation occurs after enablement of the notification. For example, if the apparatus utilizes a prescribed alert period, such as alerting for a full minute, if the user disables the notification, and enables the notification prior to 7:01 AM, the apparatus may cause actuation of the notification based, at least in part, on the enablement occurring during the prescribed 1 minute after actuation of the notification. In another example, the apparatus may receive the notification enablement input after the deferment period has elapsed. For example, if the deferment period is 10 minutes, the apparatus may receive the enablement input at 7:11 AM. In such circumstances, the apparatus may alert immediately, if desired, based on prior elapse of the deferment period. The apparatus may restrict the user's ability to perform the notification enablement input to a predetermined time. For example, the apparatus may avoid enablement of the notification if the predetermined time has elapsed, even if the apparatus receives a notification enablement input.

In some examples of embodiments, if more than one criterion was required to be met (for example, the combined criteria that the time is 7:00; and/or that the date also corresponds to being a week-day (for example DAY=Monday) and/or the location of the apparatus matches a location for enabling the alarm event (or conversely, does not match a location where the alarm event is not enabled), e.g. Location=Home), then a respective data structure may be provided to represented each criterion. In other examples of embodiments, a single data structure may be provided in a suitable form to represent all of the required criteria for an alarm event.

The triggering conditions for generating an alarm may also be determined by the alarm application syncing an internal clock mechanism with the external timing information provided by the apparatus. When the internal clock time matches the time criterion for an alarm event to be notified, the notification is generated after a check to see if one or more other criteria have also been indicated as needing to be met.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 1108 of FIG. 11 may be performed after block 1112 of FIG. 11. Furthermore, if desired, one or more of the above-described functions may be optional or may be combined. For example, blocks 704 and 706 of FIG. 7 may be optional and/or combined with block 504 of FIG. 5.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

1-20. (canceled)

21. An apparatus, comprising:
at least one processor;
at least one memory including computer program code, the memory and the computer program code configured to, working with the processor, cause the apparatus to perform:
causation of actuation of a notification indicative of occurrence of an event;
receipt of an indication of a notification disablement input associated with the notification;
causation of disablement of the notification based, at least in part, on the notification disablement input, such that the disablement of the notification prevents a subsequent actuation of the notification of occurrence of the event;
receipt of an indication of a notification enablement input associated with the disabled notification; and
causation of enablement of the disabled notification based, at least in part, on the notification enablement input, such that the enablement causes a subsequent actuation of the notification of occurrence of the event.

22. The apparatus of claim 21, wherein the memory includes computer program code configured to, working with the processor, cause the apparatus to perform causation of display of a notification disablement interface element, wherein the notification disablement input relates to an input that corresponds with the notification disablement interface element.

23. The apparatus of claim 21, wherein the memory includes computer program code configured to, working with the processor, cause the apparatus to perform:
causation of another actuation of the notification indicative of occurrence of the event;
receipt of an indication of a notification deferment input associated with the notification; and
causation of deferment of the notification based, at least in part, on the notification deferment input, wherein the notification indicative of the event is based, at least in part, on a determination that a deferment period has elapsed.

24. The apparatus of claim 21, wherein the disablement of the notification is distinct from a deferment of the notification of occurrence of the event.

25. The apparatus of claim 21, wherein the disablement of the notification is distinct from a disablement of the event.

26. The apparatus of claim 21, wherein the memory includes computer program code configured to, working with the processor, cause the apparatus to perform causation of display of a notification enablement interface element, wherein the notification enablement input corresponds with the notification enablement interface item.

27. The apparatus of claim 21, wherein the notification enablement input is distinct from an event enablement input.

28. The apparatus of claim 21, wherein enablement of the notification comprises setting the notification to occur after a deferment period.

29. The apparatus of claim 21, wherein the apparatus is an input device configured to receive the indication of a notification enablement input.

30. A method comprising:
causation of actuation of a notification indicative of occurrence of an event;
receipt of an indication of a notification disablement input associated with the notification;
causation of disablement of the notification based, at least in part, on the notification disablement input, such that the disablement of the notification prevents a subsequent actuation of the notification of occurrence of the event;
receipt of an indication of a notification enablement input associated with the disabled notification; and
causation of enablement of the disabled notification based, at least in part, on the notification enablement input, such that the enablement causes a subsequent actuation of the notification of occurrence of the event.

31. The method of claim 30, further comprising causation of display of a notification disablement interface element, wherein the notification disablement input relates to an input that corresponds with the notification disablement interface element.

32. The method of claim 30, further comprising:
causation of another actuation of the notification indicative of occurrence of the event;
receipt of an indication of a notification deferment input associated with the notification; and
causation of deferment of the notification based, at least in part, on the notification deferment input, wherein the notification indicative of the event is based, at least in part, on a determination that a deferment period has elapsed.

33. The method of claim 30, wherein the disablement of the notification is distinct from a deferment of the notification of occurrence of the event.

34. The method of claim 30, wherein the disablement of the notification is distinct from a disablement of the event.

35. The method of claim 30, further comprising causation of display of a notification enablement interface element, wherein the notification enablement input corresponds with the notification enablement interface item.

36. The method of claim 30, wherein the notification enablement input is distinct from an event enablement input.

37. A non-transitory computer-readable medium encoded with instructions that, when executed by a processor, perform:
causation of actuation of a notification indicative of occurrence of an event;
receipt of an indication of a notification disablement input associated with the notification;
causation of disablement of the notification based, at least in part, on the notification disablement input, such that the disablement of the notification prevents a subsequent actuation of the notification of occurrence of the event;
receipt of an indication of a notification enablement input associated with the disabled notification; and
causation of enablement of the disabled notification based, at least in part, on the notification enablement input, such that the enablement causes a subsequent actuation of the notification of occurrence of the event.

38. The non-transitory computer-readable medium of claim 37, further encoded with instructions that, when executed by the processor, perform:
causation of display of a notification disablement interface element, wherein the notification disablement input relates to an input that corresponds with the notification disablement interface element.

39. The non-transitory computer-readable medium of claim 37, further encoded with instructions that, when executed by the processor, perform:
causation of another actuation of the notification indicative of occurrence of the event;
receipt of an indication of a notification deferment input associated with the notification; and
causation of deferment of the notification based, at least in part, on the notification deferment input, wherein the notification indicative of the event is based, at least in part, on a determination that a deferment period has elapsed.

40. The non-transitory computer-readable medium of claim 37, wherein the disablement of the notification is distinct from a deferment of the notification of occurrence of the event.
